(19) United States
(12) Patent Application Publication
(10) Pub. No.: US 2008/0109232 A1
(43) Pub. Date: May 8, 2008

(54) Evaluative information system and method

(75) Inventors: Timothy A. Musgrove, Morgan Hill, CA (US); Peter Ridge, San Jose, CA (US); Robin Walsh, San Francisco, CA (US)

Correspondence Address: NIXON PEABODY, LLP, 401 9TH STREET, NW, SUITE 900, WASHINGTON, DC, 20004-2128, US

(73) Assignee: CNET Networks, Inc., San Francisco, CA (US)

(21) Appl. No.: 11/808,263

(22) Filed: Jun. 7, 2007

Related U.S. Application Data
(60) Provisional application No. 60/811,429, filed on Jun. 7, 2006.

(51) Int. Cl. G06Q 99/00

(52) U.S. Cl. 705/1

(57) ABSTRACT

A system and method for aggregating and organizing evaluative information for a particular product from at least one information source. An evaluation summary is generated by the system and method which gives users a quick and convenient view of the overall trends among the evaluative information available, including such information users and reviewers have expressed toward the particular product. The generated evaluation summary may include a category summary and a product summary.

This application claims priority to U.S. Provisional Application No. 60/811,429 filed Jun. 7, 2006, the contents of which are incorporated herein by reference.

### BACKGROUND OF THE INVENTION

1. Field of the Invention

The present invention is directed to a system and method that aggregates, organizes, and summarizes evaluative information from an evaluative information source.

2. Description of Related Art

Many different products and services are provided from product and service vendors. For example, manufacturers of a particular category of product offer various models in their product line, each model targeting a particular group of users and/or meeting the specific needs of a market segment. Of course, providers of services also typically provide numerous different services in their field. Such providers of services may include telecommunications companies such as wireless service providers, utilities such as cable and satellite broadcast providers, travel companies including airlines, cruise lines and travel agencies, etc.

Presently on the Internet, there are very many information sources and a great diversity of information content for almost any product or service, product and/or service being simply referred to herein as a “product”. Various websites provide forums for users of the products to review, and provide their opinions, i.e. commentaries, regarding the various products. For example, websites such as www.mysimon.com and www.yahoo.com provide links to allow users to research products, and to provide their review as well as reading review and opinions of others. Websites such as www.epinions.com are specifically optimized to allow users of various products to provide reviews and opinions regarding products in various product categories, and to allow such users to read those reviews and opinions of others. Still other websites such as www.cnet.com provide professional narrative product summaries that highlight various features of the particular product, and discuss strengths and weaknesses of the reviewed product in comparison to other comparable products. Such websites also may include links to user opinions and reviews.

These reviews, opinions, commentaries, etc, regarding a particular product from professionals and users of the products are collectively referred to herein as “evaluative information” since they provide an evaluation of the particular product. Such evaluative information may be used by consumers to facilitate potential purchase decisions. Moreover, sources of such information such as the above noted web sites, as well as other web sites and sources of product information, are collectively referred to herein as “information sources”.

In many respects, the availability of vast amount of evaluative information for products is very beneficial, but in some respects, it can be very frustrating to the users of the evaluative information. In the domain of e-commerce, while users are happy that they can obtain advice and commentary on a variety of products, they are often overwhelmed by the magnitude of the evaluative information available and provided. It is often difficult for the user to distill the essence, or to grasp the trend, of what is being reported by a variety of users, reviewers, journalists, etc., regarding a particular product.

Therefore, there exists an unfulfilled need for a system and method that facilitates the aggregation, organization, and summarization of evaluative information for products from a diverse plurality of sources.

### SUMMARY OF THE INVENTION

Presently, summaries of all the evaluative information for particular products are not available, except in the most superficial respect. For example, currently existing systems and methods for facilitating evaluation of products merely provide a very simplified review of a particular product, even though there may be hundreds of instances of evaluative information regarding the particular product that describe the specific strengths and/or weaknesses of the product. Presently, the user may be provided with a grand total, or an average scoring, of the final verdicts that are provided by the users. For instance, grand total of the “thumbs up” vs. “thumbs down” votes, or the average “3.5 out of 5 stars” rating is typically provided. Thus, currently existing systems and methods do not provide anything more refined or detailed information that is based on the evaluative information available.

However, most users will want to know more refined information for a particular product which is not reflected in such a coarse scoring information presently available. Many users will want to know which characteristics were most commonly praised, or negatively criticized about the product. In pursuit of this knowledge, the user will often need to spend several hours searching for, and reading through, the evaluative information (including reviews, commentaries and opinions) that can be provided on a variety of different web sites.

In addition, if a user is interested in a particular feature or aspect of the products in a product category, and wants to know the overall reaction of users to one particular aspect or feature of that product, the above research is, for all intents, mandatory. For example, if a user is interested in a digital camera specifically for outdoor sports action photography, then the user will care less about the camera's overall average rating, and care more about what evaluative information from other users (or reviewers) have said about this particular application scenario, i.e. outdoor sports action photography. The user will have to spend hours reading the evaluative information from various information sources to come to a conclusion regarding whether the particular camera is well suited for the anticipated and intended use. Because this research process requires both time and skill, most users simply do not engage in the activity at all, and thus, are deprived of good information that is available, albeit cumbersome to use.

In view of the foregoing, an advantage of the present invention is in providing an evaluative information system and method that facilitates aggregation of evaluative information for products from an information source.

Another advantage of the present invention is in providing such a system and method that organizes the evaluative information for facilitating use of the aggregated evaluative information.

Still another advantage of the present invention is in providing such a system and method that processes the aggregated evaluative information to generate category summaries and product summaries based on the aggregated evaluative information.

Correspondingly, the system and method in accordance with one embodiment of the present invention provides a substantially automated system for aggregating and organizing evaluative information for a particular product from an evaluative information source. An evaluation summary is generated by the system and method of the present invention which gives users a quick and convenient view of the overall trends among the evaluative information available, including such information users and reviewers have expressed toward the particular product. In this regard, the generated evaluation summary may include a category summary and/or a product summary. Furthermore, excerpts from the evaluative information can be presented in support of the evaluation summary provided. The evaluation summary further facilitates the ability for those users to focus on just those attributes or features that draw their particular interest. Correspondingly, the evaluative system and method is adaptive and scalable.

In view of the above, in accordance with one aspect of the present invention, an evaluative information system for summarizing evaluative information from at least one information source is provided. In one embodiment, the evaluative information system includes a processor adapted to electronically communicate with the plurality of information sources, an aggregator module adapted to locate and aggregate evaluative information regarding a product in a product category from the plurality of information sources, an analyzer module adapted to extract evaluative features in the evaluative information aggregated by the aggregator module, and a generator module adapted to generate an evaluation summary for the product based on the extracted evaluative features so as to summarize evaluative information from the information source.

In another embodiment, the aggregator module is further adapted to aggregate names of products in the product category from an intermediary web site. In still another embodiment, the analyzer module utilizes a plurality of text patterns to extract the evaluative features in the evaluative information aggregated. In addition, the analyzer module may be further adapted to extract secondary attributes in the evaluative information aggregated and the evaluation summary for the product may be generated further based on the extracted secondary attributes. In yet another embodiment, the generator module is further adapted to generate a summary for the product category of the product based on the extracted evaluative features.

In accordance with another embodiment, the evaluative information system further includes an excerpt generator that copies excerpts of the evaluative information to generate excerpts for publication. In this regard, at least a portion of the generated excerpts are incorporated into the evaluation summary for the product. In addition, at least a portion of a generated excerpt may be provided as a hyperlink to the text of the evaluative information of the information source from which the excerpt was copied. Furthermore, the generated evaluation summary may include at least one evaluative feature which is provided as a hyperlink to a generated excerpt. Moreover, in yet another embodiment, the evaluative information system also includes a publisher module adapted to electronically publish the evaluation summary for the product generated by the generator module.

In accordance with another aspect of the present invention, a computer implemented method for processing evaluative information from at least one information source is provided. In accordance with one embodiment, the method includes electronically locating and aggregating evaluative information regarding a product in a product category from the information source, electronically extracting evaluative features in the evaluative information aggregated, and electronically generating an evaluation summary for the product based on the extracted evaluative features so as to summarize evaluative information from the information source, and electronically publishing the generated evaluation summary. In accordance with another embodiment, the method includes steps performed by the various modules described above.

In accordance with yet another aspect of the present invention, a computer readable medium for processing evaluative information from at least one evaluative information source is provided, the medium including instructions for implementing the above described evaluative information system and/or the computer implemented method.

These and other advantages and features of the present invention will become more apparent from the following detailed description of the preferred embodiments of the present invention when viewed in conjunction with the accompanying drawings.

### BRIEF DESCRIPTION OF THE DRAWINGS

FIG. 1 is a schematic illustration of an evaluative information system in accordance with one example embodiment of the present invention.

FIG. 2 is a flow diagram illustrating a method for processing evaluative information in accordance with another aspect of the present invention.

FIG. 3 is an enlarged schematic illustration of a content aggregator module in accordance with one example embodiment.

FIG. 4 is an enlarged schematic illustration of an analyzer module in accordance with one example embodiment.

FIG. 5 is an enlarged schematic illustration of a generator module in accordance with one example embodiment.

FIG. 6 is a category screen generated by the generator module of the evaluative information system in accordance with one embodiment.

FIG. 7 is a product screen generated by the generator module of the evaluative information system in accordance with one embodiment.

FIG. 8 is the product screen of FIG. 7 which has been scrolled to the bottom of the page.

FIG. 9 is another category screen generated by the generator module of the evaluative information system.

FIG. 10 is another product screen generated by the generator module of the evaluative information system.

FIG. 11 is the product screen of FIG. 10 which has been scrolled down.

FIG. 12 is a user opinion screen which incorporates a product summary generated by the evaluative information system in accordance with another embodiment of the present invention.

FIG. 13 is the user opinion screen of FIG. 12 in which “Pros” link has been selected.

FIG. 14 is the user opinion screen of FIG. 12 in which “Cons” link has been selected.

### DETAILED DESCRIPTION OF THE PREFERRED EMBODIMENT

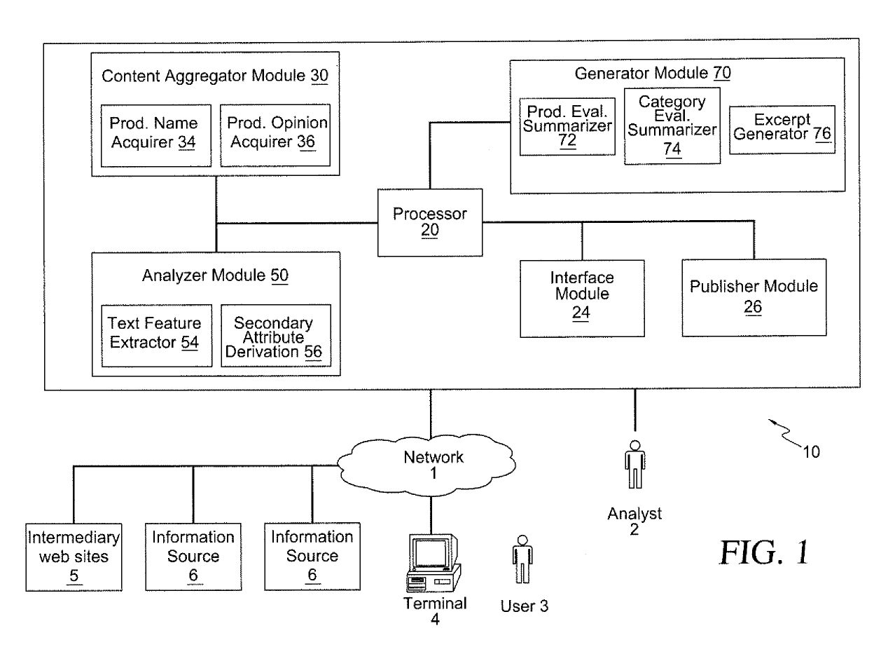

FIG. 1 is a schematic illustration of an evaluative information system 10 in accordance with one embodiment of the present invention. As explained in further detail below, the evaluative information system 10 is implemented to aggregate, organize, and summarize the evaluative information for particular products so as to provide users a quick and convenient summary of the overall trends and differentiating reactions and opinions that a variety of other users and reviewers have expressed toward a particular product. Thus, the users of the evaluative information system 10 do not need to spend several hours searching for, and reading through, numerous evaluative information as reviews, commentary and opinions, on a variety of different information sources, to obtain the desired information regarding a particular product (although such task can also be undertaken if desired for some reason).

In accordance with the illustrated embodiment of the present invention, evaluative information system 10 is provided with a processor 20 which is adapted to control and/or facilitate functions of various modules and sub-modules of the evaluative information system 10 as described in detail below. It should be initially noted that the evaluative information system 10 of FIG. 1 may be implemented with any type of hardware and software, and may be a pre-programmed general purpose computing device. For example, the evaluative information system 10 may be implemented using a server, a personal computer, a portable computer, a thin terminal, a hand held device, a wireless device, or any combination of such devices. The evaluative information system 10 may be a single device at a single location or multiple devices at a single, or multiple, locations that are connected together using any appropriate communication protocols over any communication medium such as electric cable, fiber optic cable, any other cable, or in a wireless manner using radio frequency, infrared, or other technologies.

It should also be noted that the evaluative information system 10 in accordance with one embodiment of the present invention is illustrated and discussed herein as having a plurality of modules, sub-modules and/or components which perform particular functions. It should be understood that these modules are merely schematically illustrated generally based on their function for clarity purposes only, and do not necessary represent specific hardware or software. In this regard, these modules and/or sub-modules may be hardware and/or software implemented to substantially perform the particular functions explained. Moreover, two or more of these modules may be combined together within the evaluative information system 10, or each module may be divided into more modules based on the particular function desired. Thus, the present invention as illustrated in FIG. 1 should not be construed to limit the evaluative information system 10 of the present invention, but be understood as merely showing one schematic illustration of a representative implementation.

In the illustrated embodiment, the evaluative information system 10 is also connected to a network 1 that allows publishing and remote access to the evaluative information system 10 so that the product information and data can be processed and/or retrieved. In this regard, the network 1 allows the evaluative information system 10 or administrators thereof, such as analysts 2, to access other sources including intermediary web sites 5, such sites including shopping portals, search engines, etc. as described in further detail below. The network 1 also allows the evaluative information system 10 to access the various information sources 6 for product information and/or evaluative information, such information sources including, but not being limited to, manufacturers' web sites, vendors' web sites, and review and opinion web sites. In addition, the network 1 allows users 3 to access the evaluative information system 10, and obtain the information provided thereby, via a terminal 4 which can be implemented in any appropriate manner, for example, as a personal computer, a portable computer, a hand held device, a wireless device, etc.

The network 1 itself, may be any type of communications channel, a local area network (LAN), a wide area network (WAN) such as the Internet, direct computer connections, and may be accomplished in a wireless manner using radio frequency, infrared, or other technologies, using any type of communication hardware and protocols. The specific details of the above referenced devices and technologies are well known, and thus, omitted herein.

In accordance with the illustrated embodiment of FIG. 1, the evaluative information system 10 includes various modules that accesses and utilizes the processing power of the processor 20 to perform various functions, the primary functions thereof being briefly discussed herein, and discussed in further detail below. In particular, the evaluative information system 10 includes an interface module 24 that allows analysts 2 or other authorized individuals, to interface with the evaluative information system 10 to initiate various functions as described, and to maintain the evaluative information system 10. The interface module 24 further provides a navigation interface which allows the user 3 to retrieve the summaries and/or the excerpts provided by the evaluative information system 10 as described herein.

The evaluative information system 10 also includes an aggregator module 30 that functions to locate and aggregate text of evaluative information including reviews, commentaries and opinions concerning products in a product category. The aggregator module 30 of the illustrated embodiment includes the sub-modules product name acquirer 34, and a product opinion acquirer 36. The product name acquirer 34 functions to determine the names and equivalent name variations for current products so that such names and variations need not be manually entered individually by an analyst 2. The product opinion acquirer 36 functions to acquire discrete evaluative information texts corresponding to each product name from the information sources 6 which again, may be a plurality of web sites or other product information sources.

The evaluative information system 10 also includes an analyzer module 50 that functions to extract evaluative features from the evaluative information, as well as various meta-data. As used herein, evaluative feature refers to any text that represents or is indicative of an evaluation or judging of the product, a feature of the product, or characteristics of the product. Examples of evaluative features include texts in the evaluative information that are praises, condemnations, ease-of-use comments, statements on reliability or durability, etc. Of course, these are examples of evaluative features only, and the present invention is not limited to these evaluative features. As can be appreciated, such evaluative features are prevalent in evaluative information such as user reviews, commentaries, and opinions regarding products.

In the above regard, in the illustrated implementation, the analyzer module 50 includes text feature extractor 54, and a secondary attribute extractor 56 sub-modules. The text feature extractor 54 functions to extract evaluative features found in the evaluative information texts located and aggregated by the aggregator module 30 using a plurality of text patterns. The secondary attribute extractor 56 utilizes these evaluative features at a higher level, such as determining those features that apply across all of the products of a particular brand, or which feature occurs most often, both negatively and positively, for a certain product, etc.

The evaluative information system 10 further includes a generator module 70 which uses the extracted evaluative features, the derived secondary attributes, and the metadata from the analyzer module 50, to generate natural language summaries and other useful information regarding products which can be accessed and viewed by the user 3 via terminal 4. In the illustrated embodiment, the generator module 70 has various sub-modules including a product evaluation summarizer 72, a category evaluation summarizer 74, and an excerpt generator 76. In general, the product evaluation summarizer 72 utilizes extracted evaluative features from the analyzer module 50 to generate natural language product summaries indicating the trends emerging from a plurality of product reviews on specific products. The category evaluation summarizer 74 performs similar functions, but at the higher levels, so as to generate summaries of each brand of product, and the category as a whole. The excerpt generator 76 copies snippets, i.e. excerpts from the original reviews, commentaries and/or opinions from the information sources 6 that was aggregated, and clusters them together in correspondence to the various features so as to facilitate summarizing of these features.

Finally, a publisher module 26 is provided in the illustrated embodiment of the evaluative information system 10 which utilizes the outputs of the generator module 70 to organize and publish for the user 3, the category summaries and product summaries in a website environment that is easily navigable using the interface module 24, and/or produce code that is readily viewable via insertion into an existing website. In particular, the publisher module 26 in one preferred embodiment creates one or more summary pages that provide links to product pages and clusters of excerpts generated by the excerpt generator 76. Thus, the publisher module 26 functions to provide the outputs of evaluative information system 10 in a way that is easy for users 3 to understand and to navigate to obtain the desired information regarding the particular product.

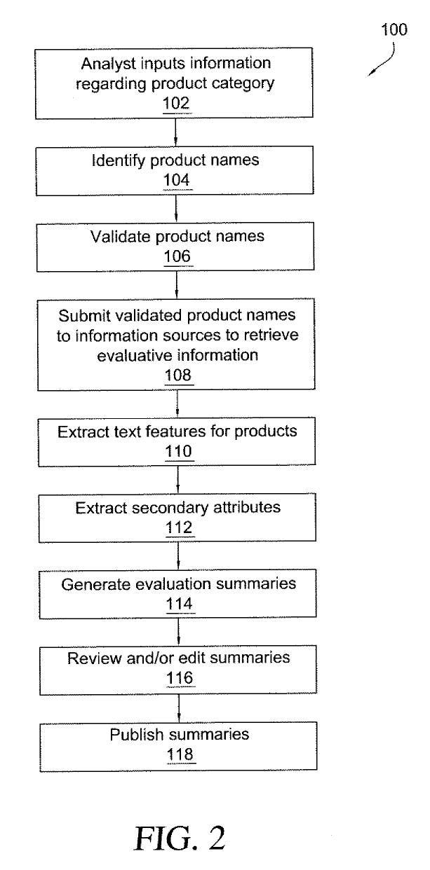

Prior to discussing the particular functions and features of the above noted modules and sub-modules of the evaluative information system 10, the general method processing evaluative information is discussed herein relative to FIG. 2 that illustrates a flow diagram 100 in accordance with one embodiment to enhance understanding of the evaluative information system 10.

In the preferred implementation, the analyst 2 or other individual that is familiar with a particular product category accesses the evaluative information system 10 to provide the foundational knowledge for a particular product category. The analyst 2 is those individuals who have significant knowledge of a product category, including major brands and features of such products. It should be noted that such individuals need not qualify as product “experts”, thereby reducing costs of implementing the evaluative information system 10. The analyst 2 focuses on one product category at a time, and inputs knowledge regarding the product category into the evaluative information system 10 via the interface module 24 in step 102. In other implementations, such foundational knowledge for a particular product category may already be electronically available, for example, in an electronic catalog.

In step 104, the name acquirer 34 of the aggregator module 30 is used in conjunction with the analyst's 2 configurations or instructions to identify the names of products in the particular product category, and product lists of candidate product names are generated. This can be attained by submitting the analyst's 2 configurations or instructions to various intermediary web sites 5 that serve as portals for sales of products in the product category, for example, www.mysimon.com, www.froogle.com, www.nextag.com, etc. The identified product names are validated in step 106 to identify and remove spam entries, mis-categorized items, duplicate items, etc. from the product lists generated by the aggregator module 30.

Referring again to FIG. 2, in step 108, the list of product names acquired in step 106 are submitted to evaluative information and content bearing web sites (i.e. information sources 6) using the product opinion acquirer 36 of the aggregator module 30 which is implemented to properly extract the relevant evaluative information, for example, the user opinions, commentaries, reviews, etc., for each product name. Such evaluative information and content bearing information source web sites 6 include, for example, www.crutchfield.com, www.amazon.com, www.epimons.com, etc.

In accordance with the present method, analysis of the extracted evaluative information and content begins by extracting evaluative features such as praise, condemnation, ease-of-use comments, statements on reliability or durability, etc., in step 110 using the text feature extractor 54 of the analyzer module 50. In addition, secondary attributes, such as overall praises or comments regarding the brand of the particular product, are also drawn from the extracted evaluative information content in step 112 using the secondary attribute extractor 56.

In addition, in step 114, the evaluative features and secondary attributes from steps 110 and 112 are used by the generator module 70, together with shallow linguistics, micro-grammar, and sentence/paragraph templates, to generate natural language evaluation summaries for the product category and each of the particular products of the product category. The analyst 2 reviews the generated evaluation summaries in optional step 116 to make any corrections or edits. Step 116 is optional in the sense that the human review step can be minimized or even eliminated after sufficient performance and quality levels are achieved so that the generated evaluation summaries, etc. can be published automatically. Finally, the evaluation summaries and the various content and meta-data are published in step 118 using the publisher module 26. Of course, the above described method of flow diagram 100 is provided as merely one example, and the present method is not limited thereto.

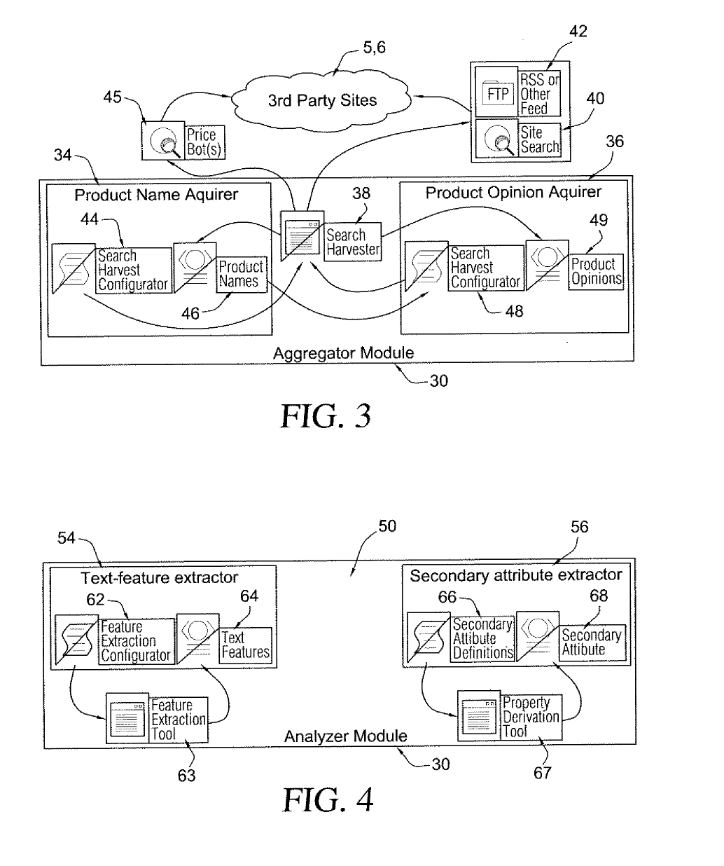

The particular functions and features of the above noted modules and sub-modules of the evaluative information system 10 are discussed in detail below. More specifically, the content aggregator module 30 is adapted to automatically aggregate evaluative information and other information regarding products in a product category, these functions of the content aggregator module 30 being schematically shown in FIG. 3. In this regard, the content aggregator module 30 is adapted to aggregate such information by searching, crawling, and/or parsing, web sites that include intermediary web sites 5 and information sources 6 as shown in FIG. 1.

As previously noted, the intermediary web sites 5 are those that index or point to the information sources 6, and include www.mysimon.com, www.froogle.com, www.nextag.com, etc. The information sources 6 include those web sites that have product-related evaluative content and information such as product reviews or opinions, whether from consumer or professional authors, or both. Again, such information sources 6 include web sites such as www.crutchfield.com, www.amazon.com, www.epinions.com, etc. that provide reviews, commentary, and opinions, associated with a particular product.

The reason for implementing the evaluative information system 10 so that it uses intermediary web sites is that, initially, the evaluative information system 10 may not have the product names of all products in the product category. However, product names in a product category are readily available in such intermediary web sites 5. Thus, this information can be easily acquired by evaluative information system 10 by simply submitting a product category or other descriptive text related to the products of interest to the search engines provided in such intermediary web sites.

As shown in FIG. 3, the content aggregator module 30 is preferably implemented with a “search harvester” 38 tool that can be used by sub-modules of the content aggregator module 30 including the product name acquirer 34 and the product opinion acquirer 36. As used herein, “search harvester” 38 refers to any engine program or tool capable of programmatically retrieving information according to input parameters, and post-processing the initial search results to ensure that only some particular types of information from the initial search results are finally provided as the output. Various existing technologies in the search and results processing technology art can be used for the search harvester. For instance, numerous crawler script engines, search engine results page manipulators, configurable web crawlers already known and existing in the art can be used, provided that they are utilized with sufficient preparation and scripting. Examples of such existing technologies that can be used include, but are not limited to, the VLASYS engine of CNET Networks of San Francisco, Calif., U.S.A., and the SERP-Slicer of MTE, LLC. of Morgan Hill, Calif., U.S.A. Of course, any appropriate engine can be used in implementing the search harvester 38. However, as noted, the search harvester 38 is preferably implemented to “pick from” the initial search results of one or more 3rd party search engine(s) 40. The search harvester 38 can also be implemented so that it could access and obtain information from an FTP site, RSS feed 42, or similar index of material, rather than a conventional search engine.

As explained in further detail herein below, name search harvest configurator 44 is provided in the product name acquirer 34 sub-module of the content aggregator module 30, and opinion search harvest configurator 48 is provided in the product opinion acquirer 36 sub-module. The search harvest configurators are instructions that configure the search harvester 38 tool so that, together with the analyst's 2 inputted instructions, the search harvester 38 performs the desired function of acquiring product names or acquiring product evaluative information.

In particular, as previously described, the product name acquirer 34 of FIG. 3 utilizes the search harvester 38 to access third party intermediary web sites 5 to locate product names of product categories en masse, based on the analyst's 2 instructions and configuration of the search harvester 38 by the search harvest configurator 44 for locating and collecting such names. In this regard, the search harvester 38 is preferably implemented to employ a combination of automated-navigation (controlled, filtered crawling) and automated-search methods, to obtain, and filter product names, and further perform periodic refreshing.

More specifically, the schematically illustrated name search harvest configurator 44 is implemented to translate the input of the analyst 2 as described above relative to step 102 of the flow diagram 100 in FIG. 2, into control parameters needed by the search harvester 38 to complete the desired task of acquiring product names in step 104. In this regard, query spawning rules and search results validation rules are entered by the analyst 2. In many cases, these are as simple as static keywords, or can be represented in a more complex manner such as via regular expressions or other forms of patterns and rules that are associated with a particular product category. For example, in the product category of Digital Cameras, the analyst 2 would include the simple rule to input “digital camera” as a query in the name search harvest configurator 44. Such input is provided to the search harvester 38 that electronically submits the input to the intermediary web site 5, for example, to a search engine provided in the intermediary web site 5. All of the product names that are retrieved as results by the intermediary web site 5 are stored as a listing of product names in product names file 46 that is the output of the product name acquirer 34. In the illustrated embodiment, the intermediary web site 5 is a “pricebot” 45 or comparison shopping type of search engine, which returns a listing of product names.

In the preferred implementation of the present invention, the product names identified should be verified as noted relative to step 106. For example, such a query may also return many other products associated with digital cameras, such as leather cases for digital cameras, and not just digital cameras themselves. In such a case, the analyst 2 preferably adds a search result validation rule so as to exclude results that have a category label that includes the words “case” and/or “accessory”. The particular formulation of such rules could be of many forms. For example, alternative embodiments may include a comma delimited file prepared by the analyst 2 or a web-based user interface for entering the rules. Such tools and techniques that can be used by the analyst 2 to validate each of the search results are known in the art and thus, are not described in further detail herein.

Of course, additional features may be extracted by the search harvester 38 in order to validate that the identified product belongs to the product category in question. Constraints can be defined by the analyst 2 and applied by the product name acquirer 34. The constraints may be textual, as in the product name constraints discussed above, or arithmetic, such as defining an acceptable price range for a product within the product category.

In addition to the problem of returning peripheral items discussed above, duplicate items may also be returned which further complicates the matter. These duplicates may have the same, or simply similar, names. For example, “Creative Zen Multimedia Player”, “Creative Zen Multimedia Player Blue”, “Creative Zen Multimedia Player Red” can all be considered essentially the same product, the only variation being in the color. Correspondingly, in the preferred implementation of the present invention, the aggregator module 30 invokes an external mechanism (not shown) to consolidate such duplicate products. There are a variety of clustering and related technologies for detecting, and eliminating, duplicate items such as these including CNET's Product Catalog Aggregation Apparatus which is described in detail in U.S. Pat. No. 7,082,426 that issued on Jul. 25, 2006, entitled “Content Aggregation Method and Apparatus for On-Line Purchasing System,” the contents of which are incorporated herein by reference. Of course, the Product Catalog Aggregation Apparatus is merely one example of a device that can be used to detect and eliminate duplicate items, and other devices can be used in other implementations. However, an important requirement of such a device is that it utilizes strings or tokens indicating or contra-indicating a likelihood of sameness, or difference, between the products.

Although these duplicates are a problem in deducing a non-superfluous list of products, the duplicates are virtuous in that they provide valid alternate designations for the products being sought after. These alternate designations may be useful when attempting to retrieve product and evaluative information from additional information sources which may, themselves, have varying designations for these products.

Thus, in view of the above, the product name acquirer 34 sub-module provides to the search harvester 38, the required name search harvest configurator 44 so that the search harvester 38 acquires from a intermediary web site 5 such as pricebot 45, the names of products in a product category which can be provided in a product names file 46 as the output of the product name acquirer 34. It should also be evident that the search harvest configurator 44 is implemented to provide sufficient instruction so such names acquired can be validated.

As previously explained, information sources 6 such as web sites that are known by the analyst 2 to bear numerous evaluative content information (such as reviews, commentaries and/or opinions) pertaining to products in the category are identified via the interface module 24. Referring again to FIG. 3, once this identification is made, the opinion search harvest configurator 48 of the product opinion acquirer 36 is provided to the search harvester 38 to properly configure the search harvester 38 so that it can obtain evaluative information from such information sources 6. In this regard, each of the verified product names of the product names file 46 which was acquired by the product name acquirer 34 is submitted to the evaluative information content-bearing information sources 6 as discussed relative to step 108 to retrieve the evaluative information content associated with the particular product. This may be attained sequentially, in one by one manner where each product name is submitted to the search engine 40 of the site, or as a local search on a downloaded RSS or other data feed 42. The aggregated evaluative information regarding a particular product is stored as product opinion file 49.

Using product opinions as an example of the evaluative information content being gathered, the opinion search harvest configurator 48 is preferably implemented to handle the variety of paradigms that may be used by the information sources 6 to present evaluative information content. For instance, the information source web sites may present each product with its own web page that contains one or more opinions; present multiple products listed on a single page; present product opinions in one continuous block of text; present product opinions that are broken into multiple blocks such as “pros” vs. “cons”; present product opinions on one or more pages with one or more opinions per page, etc. Of course, these variations are only provided as examples of different presentations that may be used by different information sources 6 and there may still be others.

Some of the aforementioned variations introduce additional complexity to the opinion search harvest configurator 48. For example, the existence of opinions on one or more pages depending upon the number of opinions available for a particular product requires that the search harvester 38 be flexible enough to know when more pages exist, and are required to be subsequently harvested. Thus, the product opinion acquirer 36 preferably includes built-in, adaptive configurations of the opinion search harvest configurator 48 for either single-product-page oriented, multiple-product-list oriented sites, etc., so as to obtain product opinion content from such sites on an automated basis, with periodic refreshing.

In aggregating the evaluative information content, the product opinion acquirer 36 is also preferably adapted to recognize variant forms of evaluative information that are prominent in the world of product advice and marketing on the Internet. In this regard, the search harvest configurator 48 is also implemented to allow the search harvester 38 to recognize and aggregate these variant forms of evaluative information including, but not limited to, positive opinion, negative opinion, overall opinion, scalar ratings, thematic ratings (e.g. “durability”, “quality”, etc.) and so on.

Similar to the duplicate processing done by the product name acquirer 34, an analogous duplicate processing occurs in the product opinion acquirer 36 as well, where opinions for a particular product from one site may, or may not, apply to a similarly named product from another site. For example, opinions for a “Dell Optiplex 270” would be very relevant to opinions for a “Dell Optiplex 270 with LCD monitor.” On the other hand, opinions for “Microsoft Windows XP Home” would likely not be very relevant to opinions for a “Microsoft Windows XP Professional.” Correspondingly, the product opinion acquirer 36, and in particular, the opinion search harvest configurator 48, are preferably implemented to associate opinions of those products in instances where high relevance is likely, but not in those where relevance is unlikely, and the product opinion acquirer 36 may be implemented to recognize such variant forms and discern relevance.

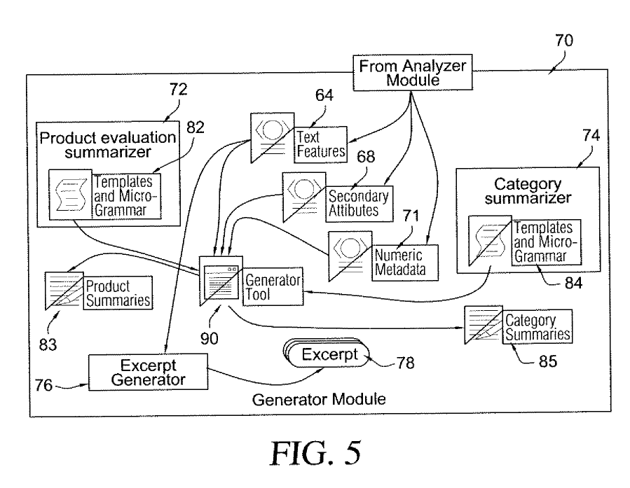

Referring again to FIG. 1 as well as FIG. 4, the analyzer module 50 analyzes the raw text and raw data of the aggregated evaluative information in the product opinion file 49 to produce various files having numeric metadata, evaluative features, and secondary attributes as discussed relative to steps 110 and 112. The numeric metadata may include, for example, the average price of a product, the portion of total products in the category that are of a particular brand, etc. Analysis of such numeric metadata is relatively simple and can be implemented using known analysis tools.

The evaluative features for which the text feature extractor 54 analyzes the aggregated evaluative information may include the names of the general features of interest for a particular product category which were entered by the analyst 2, for instance, the most common complaint associated with a particular product (for example, “uncomfortable grip”, “easily breakable”), the feature or characteristic of a product most frequently discussed, etc. In this regard, as shown in FIG. 4, the analyzer module 50 is implemented with a text feature extractor 54 sub-module that includes a feature extraction configurator 62 for allowing the analyst 2 to enter text patterns which include inflections, wildcards, regular expressions, etc.

The text patterns of the feature extraction configurator 62 are provided to a feature extraction tool 63 which analyzes the aggregated evaluative information in the product opinion file 49 to identify such text patterns therein, and generates text features file 64 for particular products that sets forth specific features and the related evaluative information that should be addressed in the category summaries and/or product summaries that are ultimately generated.

In addition, some product category-independent features that are applicable to most products, such as “quality”, “affordability” and the like are also features for which the text feature extractor 54 analyzes the aggregated evaluative information in the product opinion file 49. Such features are also included in the text features file 64. Such product category-independent features are unlikely to change after the feature extraction configurator 62 is set up for a particular product category, and portions of the feature extraction configurator 62 directed to such product category-independent features can be used across different product categories.

Of course, the text patterns entered and provided by the feature extraction configurator 62 should be compatible with the feature extraction tool 63 used so that the feature extraction tool 63 can interpret them. Various text feature extraction tools exist in the art that can be used for the feature extraction tool 63. Preferably, text feature extraction tools that have been especially developed for product content parsing can be advantageously used for the feature extraction tool 63. An example of such a specialized tool includes CNET's Product Opinion Analyzer which is described in detail in U.S. patent Ser. No. 10/636,966 filed Aug. 8, 2003, Publication No. US 2005/0034071, entitled “System and Method for Determining Quality of Written Product Reviews in an Automated Manner”, the contents of which are incorporated herein by reference. Of course, the Product Opinion Analyzer is merely one example, and a different tool may be used in other embodiments.

The secondary attributes may include multiple text features and/or numeric metadata, such as the features most often praised in the overall product line of the most-praised brand. For example, the secondary attribute for the product Titleist golf balls may be that they are the most praised brand, and that this position rests on the strength of their consistency of play from one ball to the next and under different conditions. In this regard, the secondary attribute extractor 56 sub-module of the analyzer module 50 includes secondary attribute definitions 66 with various attribute definitions for a particular product category which may be provided by the analyst 2. These secondary attribute definitions 66 are provided to the property derivation tool 67 which analyzes the evaluative information content aggregated by the content aggregator module 30 identify the secondary attributes therein, and generates secondary attributes file 68 for particular products as discussed relative to step 112 that sets forth specific secondary attributes and the related evaluative information that should be addressed in the category summaries and/or product summaries that are ultimately generated.

In an example implementation, the generated secondary attributes file 68 includes brand-level, class-level, and category level characteristics. Various engines can be utilized for implementing the property derivation tool 67, including simple Prolog or LISP based programs. Another such tool which is especially suited to product-oriented secondary attributes is CNET's Product Capsule Generator which is described in detail in U.S. patent Ser. No. 10/430,479 filed May 7, 2003, Publication No. US 2004/0225651, entitled “System and Method for Automatically Generating a Narrative Product Summary”, the contents of which are incorporated herein by reference. Of course, the Product Capsule Generator is merely one example, and other tools may be used in other embodiments.

It should also be noted that the above described process for determining the evaluative features and the secondary attributes requires accommodation of the inevitable synonymy, or various ways of referring to similar evaluative features. For instance, “reliable” and “consistent” can often be used interchangeably in evaluative information such as user reviews, commentaries and opinions. Such synonymy may be addressed by the analyst 2 by entering text patterns, or words and phrases also as hyponyms and hypernyms into the feature extraction configurator 62 and the secondary attribute definitions 66.

For example, the analyst 2 may enter “durable” as a specific form (hyponym) of “high quality” whereas there may be other aspects or manners of expressing “high quality” such as “finely crafted” or “richly detailed”. In such an instance, every product that is described as “durable” may be assigned an increased point value by the analyzer module 50 as being a match for instantiating the overall feature of “high quality”, but does not infer that the same product is also “richly detailed” since that is another, different sub-type of the feature “high quality”. Of course, certain phrases may be an instance of another specific evaluative feature, for instance, “richly detailed” as well as “high-end” and “lavishly appointed” may be considered to be instances of “luxury”.

As previously described relative to step 114, the evaluative information system 10 in accordance with the present embodiment provides the user 3 with a summary of the evaluative information for a particular product based on such information aggregated from a plurality of information sources 6. In this regard, the generator module 70 is schematically shown in FIG. 5 that illustrates the high-level data flow therein. The generator module 70 utilizes a generator tool 90 in the manner described below to dynamically create summaries as it is executed, using the refreshed and analyzed evaluative information from the analyzer module 50.

As shown in FIG. 5, the generator module 70 includes excerpt generator 76, product evaluation summarizer 72, and category summarizer 74 sub-modules, the functions of which are described in further detail below. In particular, the excerpt generator 76 receives the text features file 64 provided by the analyzer module 50, and generates excerpts 78 that can be used by the product evaluation summarizer 72 and the category summarizer 74 in generation of the respective summaries in step 114.

More specifically, in the above described text feature extraction step 110 of FIG. 2, the patterns of text are grouped based on their particular features. This grouping of patterns into features offers a good opportunity to identify the most interesting and relevant groupings, and assign user-friendly names or concept words/phrases for the features that can be presented in the product summaries 83 and the category summaries 85 generated respectively by the product evaluation summarizer 72 and the category summarizer 74. An example of such assigned user-friendly names for grouped patterns of text may be the “ease of use,” “ease of setup”, “feature-richness”, etc. for a particular product. The excerpt generator 76 assigns such names to the grouping of patterns before the product evaluation summarizer 72 is invoked so that these names can be mentioned in the generated product summaries 83.

It should be appreciated that since these features are related to matching text sub-strings in the individual reviews or user opinions of specific third party opinions, evaluations, etc. as provided in the web sites of the information sources 6, it means there is a direct relation between each mentioned feature in the generated product summaries 83, and specific portions of particular third party opinion/evaluation texts that were aggregated by the content aggregator module 30 and extracted by the analyzer module 50. Of course, this direct relationship need not be based on an exact match. In this regard, the analyst 2 can utilize tools that allow morphology (including stemming inflections, and derivations) of the text indicative of the evaluative features to automatically expand the number of reviews or opinions identified by the evaluative information system 10 as being relevant to the particular evaluative features. The micro-grammar utilized by the generator module, or other available tools may be used for this purpose. Thus, such tools can be used to expand the text “install” to encompass “installed” and “installation,” for example.

The product evaluation summarizer 72 includes templates and micro-grammar file 82 that provides summary templates and grammar required to generate coherent and structured product summaries regarding the features or attributes of particular products. “Micro-grammar” as used herein, refers to partial grammar sufficient for generation of grammatically correct fill-ins for entries to the fields of the template.

The templates and micro-grammar file 82 of the product evaluation summarizer 72 are provided to a generator tool 90 that is invoked to generate product summaries 83 as shown in FIG. 5. The generator module 70 receives from the analyzer module 50, the resultant text features file 64 and the secondary attributes file 68. In addition, the generator module 70 further receives the numeric metadata 71 that was generated by the analyzer module 50 as shown in FIG. 5. The received files and information provided therein are used to populate the fields of the templates, together with micro-grammar, that are provided by the templates and micro-grammar file 82, to thereby generate the product summaries 83 regarding the features or attributes of particular products as shown.

Of course, the generator tool 90 should be implemented to utilize the templates and micro-grammar formats that are provided by the templates and micro-grammar file 82. The generator tool 70 may be implemented using the CNET's Product Capsule Generator discussed in detail in the above noted U.S. Publication No. US 2004/0225651 which also discusses the use of templates for generating summaries. In this regard, such a tool may be used to define the templates provided in the templates and micro-grammar file 82, as well as generating the product summaries 83. Again, other different tools can be used for templating, the Product Capsule Generator being merely one of many available tools that can be used. In addition, other text generators could be alternatively employed to accomplish the above by implementing an appropriate wrapper or translation module.

The category summarizer 74 sub-module of the generator module 70 likewise, includes templates and micro-grammar file 84 that provides such templates and grammar required to generate summaries regarding particular product categories. The templates and micro-grammar file 84 is provided to the generator tool 90, together with the resultant text features file 64, the secondary attributes file 68 and the numeric metadata 71. The generator tool 90 utilizes this information to populate the fields of various templates of file 84, using micro-grammar also provided, to generate coherent and structured category summaries 85 regarding particular product categories.

Thus, the category summarizer 74 is similar to the product evaluation summarizer 72 described previously, but it operates on a “higher” level than a single product, to provide category summaries 85 that are more broadly directed to a particular brand, product category, and/or class of products. The provided information content of the generated category summaries 85 may include identification of: the leading brands, the features most users are interested in, the most common complaint across the entire category or brand, and the most commonly praised benefit of ownership across the entire category or brand, etc.

Of course, other information may also be provided in the generated category summaries 85 as well, based on the output of the analyzer module 50. However, the above noted specific evaluation information provided in the generated category summaries 85, was identified as a result of historical research from CNET's leading advice-bearing websites, including consultation of focus groups and data warehousing reports that show which information users are most interested in, and in what format (e.g. visual, tabular, or prose text). Thus, the resultant category summaries 85 include a combination of summary statements and numerical information that provide a quick “landscape view” for the average user 3, into the product category or brand of a particular product being researched by the user 3.

The excerpt generator 76 of the illustrated embodiment of the generator module 70 advantageously exploits the above noted relation between each mentioned feature in the generated product summaries 83, and specific portions of specific third party opinion/evaluation texts to accomplish two important benefits. First, for each mentioned feature, the excerpt generator 76 makes the corresponding snippets of text from the third party opinions available to the publisher module 26 as synopses and/or navigational hyperlinks to the user 3, such snippets being schematically represented as excerpts 78 in FIG. 5.

In other words, the generated product summaries 83 may be implemented so that certain mentioned evaluative feature or characteristic of a particular product is provided as a hyperlink. Upon clicking the hyperlink, the user 3 can be brought to the cluster of excerpts 78 (actually extracted strings from third party opinions) supporting the assertions of the summary review of that feature. Second, the excerpt generator 76 can also ensure that the full text of such opinions is not republished, but instead, only short, relevant excerpts 78 are shown to the user 3, thus avoiding copyright issues while possibly providing additional web traffic and exposure benefits to such publishers. Of course, the above described use of hyperlinks is merely provided as one example, and other embodiments may utilize hyperlinks in a different manner. For instance, the evaluative feature may be provided as a hyperlink in the summary, upon selection of which, the user is provided with all products that include the selected evaluative feature, or have similar evaluative feature.

Finally, the described embodiment of the evaluative information system 10 in accordance with the present invention is provided with a publisher module 26 that in the illustrated implementation, provides a web site that allows the user 3 to view the generated summaries regarding a particular product via terminal 4 and network 1. In the preferred implementation, the web site content that is outputted by the publisher module 26 has a commonly used structure that is likely to be familiar to most users, and is navigable via features provided by the publisher module 26. In this regard, the publisher module 26 may provide a user interface with various selectable links, menu items and the like to facilitate the user 3 in navigation of the generated web site content. For example, a category page may be provided that includes a category summary 85 with a general description of the product category, followed by a list of products that may be sortable in various user-selectable ways. If a user clicks on a product name, they may be taken to a product summary 83 which includes more detailed information and evaluation summary of the product, together with excerpts 78 in support of the assertions in the summary.

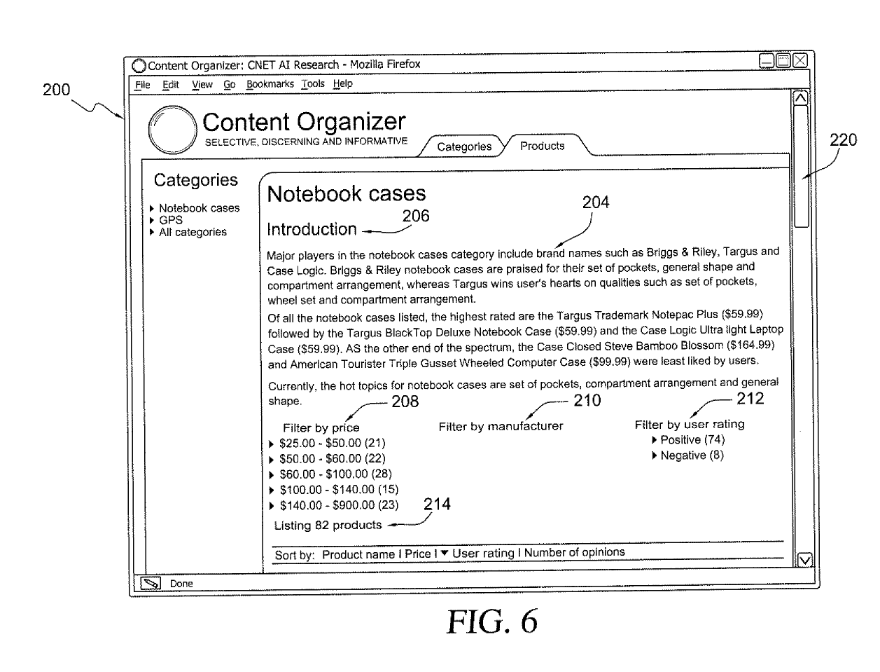

The evaluative information system 10 shown in FIG. 1 in accordance with one embodiment of the present invention has been implemented for a couple different product categories that encompass several hundred products, with evaluative information aggregated from numerous evaluative information web sites on the Internet. In this regard, FIGS. 6 to 8 show various screen shots of a browser screen in which content generated by the publisher module 26 of the evaluative information system 10 has been rendered. Of course, whereas these figures show various screen shots for the product category of “notebook cases”, the present invention can be applied to any product category (which includes services).

FIG. 6 shows a category screen 200 exemplifying a category summary 85 schematically illustrated in FIG. 5 which is generated by the generator module 70 of the evaluative information system 10. As can be seen, the category screen 200 displays for the user, general introduction information 204 under the header “Introduction” 206 regarding the particular product category selected, in the present example, “Notebook cases”. The general introduction information 204 of the category screen 200 includes summary information regarding the product category that will be of interest to the user including: the major manufacturers of the products in the product category, features considered to be strengths for products of a particular brand, highly rated products in the product category, and those features of the products which are actively discussed by the reviewers (i.e. pockets, arrangement and general shape in the illustrated embodiment). The text of the category summary is generated automatically by generator module 70 of the evaluative information system 10 using the aggregated and analyzed evaluative information regarding the particular product from a plurality of information sources 6 as previously described.

In the present illustrated implementation, the above described numeric metadata 71 is used to provide prices for the identified products, and used to generate price filter 208. Additional filters including manufacturer filter 210 and user ratings filter 212 may also be provided as shown. Furthermore, the actual products in the product category can be listed (not shown in FIG. 6) under “Listing 82 products” heading 214, the example product category of notebook cases being shown as having 82 products. The links to specific product names and prices may be viewable by scrolling down the category screen 200 using the scroll bar 220 in the manner known. Moreover, a brief product summary as generated by the generator module 70 may be provided next to each of the products listed. Of course, the above noted headers, content, and arrangement of the category screen 200 are merely provided as examples, and the present invention is not limited thereto, but may be implemented differently.

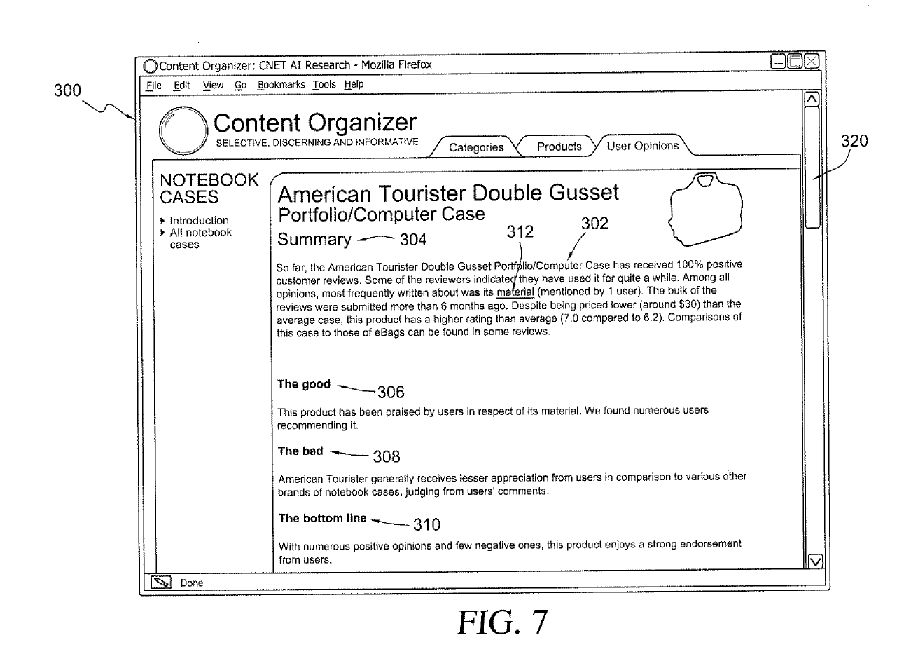

Upon selection of a specific product in the category screen 200, a product screen 300 of FIG. 7 is displayed providing detailed evaluation summary for the product selected, namely, for the American Tourister Double Gusset Portfolio/Computer Case in the present example. In this regard, FIG. 7 exemplifies a product summary 83 schematically illustrated in FIG. 5 which is generated by the generator module 70 of the evaluative information system 10. As can be seen, the product screen 300 displays for the user, an evaluation summary regarding the particular product selected under the header “Summary” 304. Again, the text of the evaluation summary is generated automatically by the evaluative information system 10 by aggregating and analyzing various evaluative information regarding the particular product from a plurality of information sources 6 such as web sites.

As shown, the product screen 300 provides an evaluation summary 302 of the selected product under the header “Summary” 304, the evaluation summary 302 being based on the reviews, commentaries and opinions that were aggregated and analyzed. The evaluation summary 302 provides a summary as to whether such evaluative information were primarily positive, neutral or negative, the feature most commonly raised, and summary comparing the rating of the selected product to others relative to the price. In addition, in the illustrated implementation, the product screen 300 is also provided with commentary regarding a comparative product that has been mentioned in the evaluative information aggregated and analyzed, if any.

Furthermore, the product screen 300 also provides summary of the aspects of the product that were praised in the evaluative information analyzed under the section header “The good” 306, as well as the aspects of the product that were criticized under the section header “The bad” 308. In addition, summaries may also be provided under these headers which compare the selected product to other comparable products. Moreover, a final commentary regarding the product based on the evaluative information is provided under the header “The bottom line”. Of course, the above noted headers, content and arrangement of the product screen 300 is merely provided as one example, and the present invention is not limited thereto, but may be implemented differently. The generated evaluative summaries regarding particular products may be referred to as “Community Briefs”, or other appropriate labeling, since they reflect the overall opinion of the community of users of the particular product.

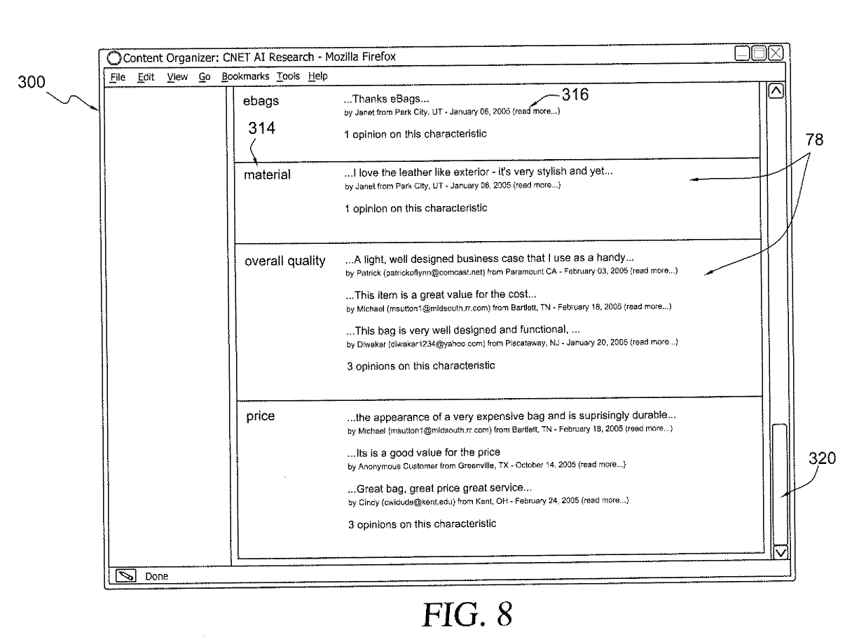

The product screen 300 of the illustrated implementation can be scrolled down using the scroll bar 320 to display a plurality of excerpts 78 from the aggregated evaluative information as previously described relative to FIG. 5. In this regard, FIG. 8 shows the bottom portion of the product screen 300 (as evidenced by the position of the scroll bar 320) that sets forth a plurality of excerpts 78 from reviews, commentaries and opinions as generated by the excerpt generator 76. As previously noted, these excerpts 78 may also be provided as hyperlinks by the publisher module 26, for example, “read more . . . ” hyperlinks 316, so that upon selection of the hyperlink for a particular excerpt of interest, the user is presented with the web page of the information source 6 which displays the full text from which the particular excerpt of interest was derived. This may be attained by navigating the open browser to the appropriate web page of the source web sites 6, by opening another browser window with the appropriate web page of the source web sites 6, or in another appropriate manner.

Referring again to FIG. 7, in the illustrated implementation of the product screen 300, the evaluative feature “material” that has been identified as having been written about by users is also provided as an underlined hyperlink 312 by the publisher module 26. Upon clicking this hyperlink 312, the portion of the web page that shows excerpt 78 of the particular review or opinion which discusses the evaluative feature of the hyperlinked word is displayed for the user. Thus, upon selection of the hyperlink 312, the browser jumps to the “material” local anchor 314 lower on the page to show the cluster of excerpts or snippets where users mentioned the “material” in their reviews, commentaries or opinions. It should be appreciated that various different reviews or opinions will likely include variant language from each user, such as “fabric,” “leather,” etc. which is recognized by the text feature extractor 54 of the analyzer module 50 as being related, and relevant, to the feature or attribute of “material”.

Furthermore, it should also be evident by examination of the product screen 300 shown in FIG. 8 that the excerpts 78 have been grouped together, and displayed for the users under appropriate descriptive headings. As previously noted, the text feature extractor 54 of the analyzer module 50 groups patterns of text based on the features, this grouping of patterns into features facilitating assignment of such appropriate descriptive headings. Thus, as shown in the product screen 300, excerpts that include phrases such as “well designed,” “great value,” etc. are clustered under the header of “overall quality” while other descriptive headings are used for other clustered excerpts. Of course, the above described implementation of the product screen 300 and its presentation of the excerpts 78 are merely provided as an example, and the present invention is not limited thereto, but may be implemented differently in other embodiments. Moreover, different navigational interface may be used in other implementations of the present invention as well.

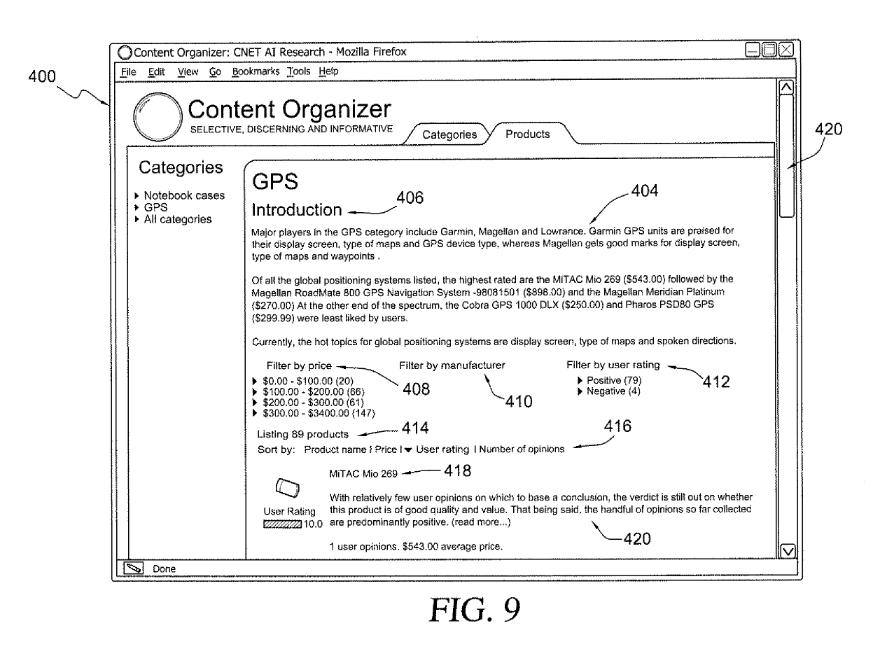

FIGS. 9 to 11 show various screen shots of a browser screen similar to FIGS. 6 to 8 discussed above, but in which content generated by publisher module 26 of the evaluative information system 10 has been rendered for the product category of “GPS”. As shown, the category screen 400 of FIG. 9 exemplifies a category summary 85 schematically illustrated in FIG. 5 that is generated by the generator module 70. The category screen 400 displays for the user 3, general introduction information 404 of interest to the user 3 regarding the product category under the header “Introduction” 406 regarding “GPS” products. The text of the category summary provided in the introduction information 404 is generated automatically by generator module 70 in the manner previously described.

Prices are also provided using the described numeric metadata 71, and used to generate the price filter 408. Additional filters including manufacturer filter 410 and user ratings filter 412 are also provided. Furthermore, the actual products in the product category are identified and listed under “Listing 89 products” heading 414, the screen shot shown in FIG. 9 merely showing one product (MiTAC Mio 269), but other products being viewable by scrolling down the category screen 400 using the scroll bar 420. Such products may be sorted based on various criteria using the sorter tool 416, which in the illustrated implementation, allows sorting by product name, price, user rating, and number of opinions.

In addition, the particular product listed is rendered as a hyperlink 418 which can be selected to obtain additional product information. In addition, in the illustrated implementation, a brief product summary 420 (which corresponds to “The bottom line” portion of the product summary) is provided for immediate review by the user 3. Again, the above noted headers, content, and arrangement of the category screen 400 are merely provided as examples, and may be implemented differently.

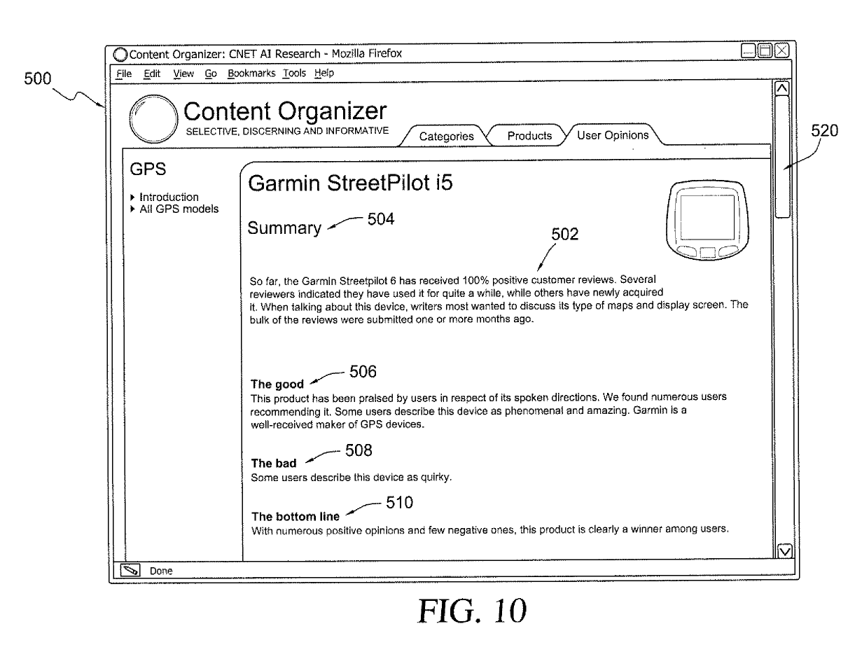

Upon selection of a specific product in the category screen 400, a product screen 500 of FIG. 10 is displayed providing detailed evaluation summary for the product selected, which in the present example, is Garmin StreetPilot i5. Thus, FIG. 10 exemplifies a product summary 83, the text of the evaluation summary being automatically generated by the generator module 70 as described, and displayed on the product screen 500 under the header “Summary” 504. The product screen 500 also provides summary of the aspects of the product that were praised in the evaluative information analyzed under the section header “The good” 506, as well as the aspects of the product that were criticized under the section header “The bad” 508. Moreover, a final commentary regarding the product is provided under the header “The bottom line” 510. Again, the above noted headers, content and arrangement of the product screen 500 is merely provided as one example.

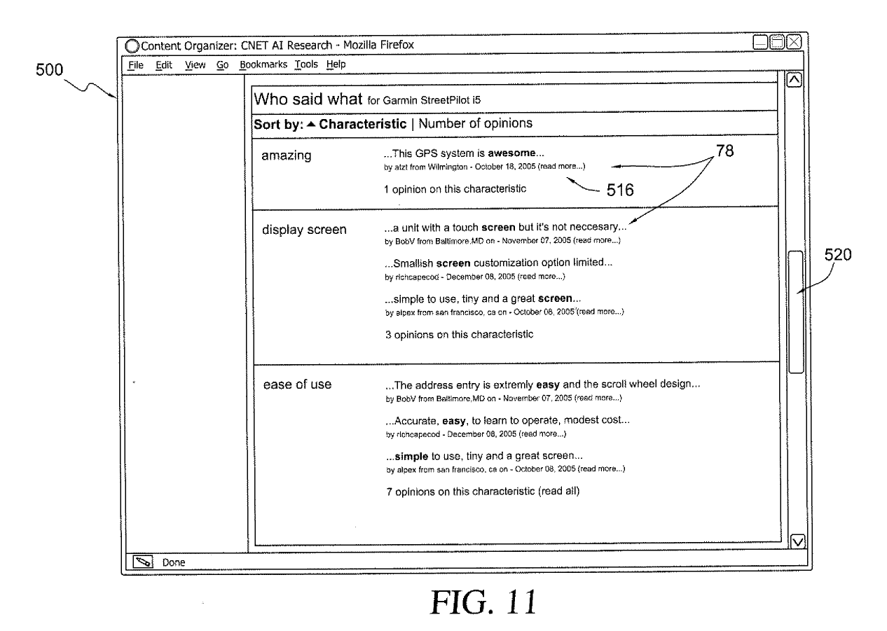

FIG. 11 shows the product screen 500 which has been scrolled down using the scroll bar 520 to display a plurality of excerpts 78 as generated by the excerpt generator 76. These excerpts 78 are provided as hyperlinks 516, so that upon selection of the hyperlink for a particular excerpt of interest, the user is presented with a web page of the information source 6 which displays the full text from which the particular excerpt of interest was derived. As shown in FIG. 11, the excerpts 78 have been grouped together, and displayed for the users under appropriate descriptive headings as well. Of course, a different navigational interface may be used in other implementations of the present invention, and the above is merely provided as one example.

The evaluative information system 10 in accordance with the present invention has demonstrated significant benefit in providing valuable evaluation summaries for products so that such information can be easily used. In addition, the output of the evaluative information system 10 including the generated category summaries, product summaries, and the excerpts, can be used for other media in addition to a web page of a web site. For example, the summaries and/or excerpts may be incorporated into an email, newsletter, magazine, newspaper, advertisement, product packaging, retail shelf placard, etc.

In addition, if a pre-existing electronic product catalog is available, the effort required to setup the evaluative information system 10 can be significantly reduced. In particular, one or more modules or sub-modules described above relative to the evaluative information system 10 can be bypassed if the available electronic product catalog already incorporates the features of such components.

In this regard, in implementing CNET's Product Capsule Generator noted above, individual product summaries have been prepared for publication within an existing website (apart from the other features and modules described relative to the evaluative information system 10). Since CNET owns a very robust product catalog and user opinion collection, some of the sub-modules within the content aggregator module 30 could be substituted or simplified by the use of already known data stored in files, databases, etc. In particular, CNET's databases already contain full lists of known products that can be readily accessed, as well as the evaluative information regarding those products. In addition, these databases contain unique identifiers for each product and evaluative information that can be used to uniquely associate one with the other, thus eliminating the problem of duplicates to begin with. Correspondingly, the functions of the product name acquirer 34 and the product opinion acquirer 36 of the content aggregator module 30 can be more limited in such instances where names, specifications and/or evaluative information regarding products are already available.

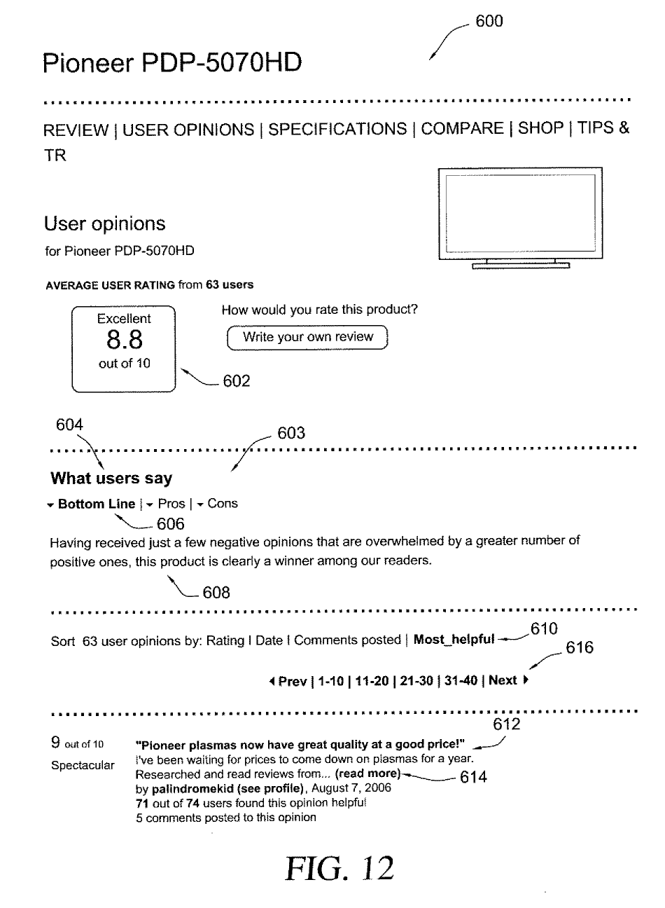

In the above regard, FIGS. 12 to 14 illustrate such an application of the evaluative information system 10 which has been implemented within an existing review web site, in particular, in www.cnet.com, which allows users to submit opinions regarding a particular product. These figures illustrate various screen shots of a user opinion screen 600 for a user selected product, in the present example, for the television Pioneer PDP-5070HD. Of course, because the evaluative information system 10 is implemented within an existing review web site, there is only one information source, and as previously noted, the intermediary web sites would not be required in the present example since the existing review web site (www.cnet.com) is provided with full lists of known products that can be readily accessed.

The user opinion screen 600 has various known features including providing a numerical average 602 of the user's numerical ratings, and displaying portions of the actual opinions 612, the full review being displayable upon selection of hyperlink “read more” 614. Of course, in FIG. 12, only one such opinion is displayed for clarity, but other such opinions can be displayed by scrolling down the user opinion screen 600, these opinions being grouped in increments of ten reviews in the present example, other groups being viewable upon selection of the desired grouping link 616. Moreover, these opinions may be sorted using the sorter tool 610 in the manner known.

The user opinion screen 600 shown is also implemented to provide product summary content generated by the evaluative information system 10. In particular, an evaluation summary section 603 is provided under the heading “What users say” 604, that sets forth the evaluation summary for the particular product as generated by the publisher module 26 based on aggregation and analysis of the opinions already available in the opinion web site (i.e. in www.cnet.com in the present example) which effectively functions as the information source 6 itself.

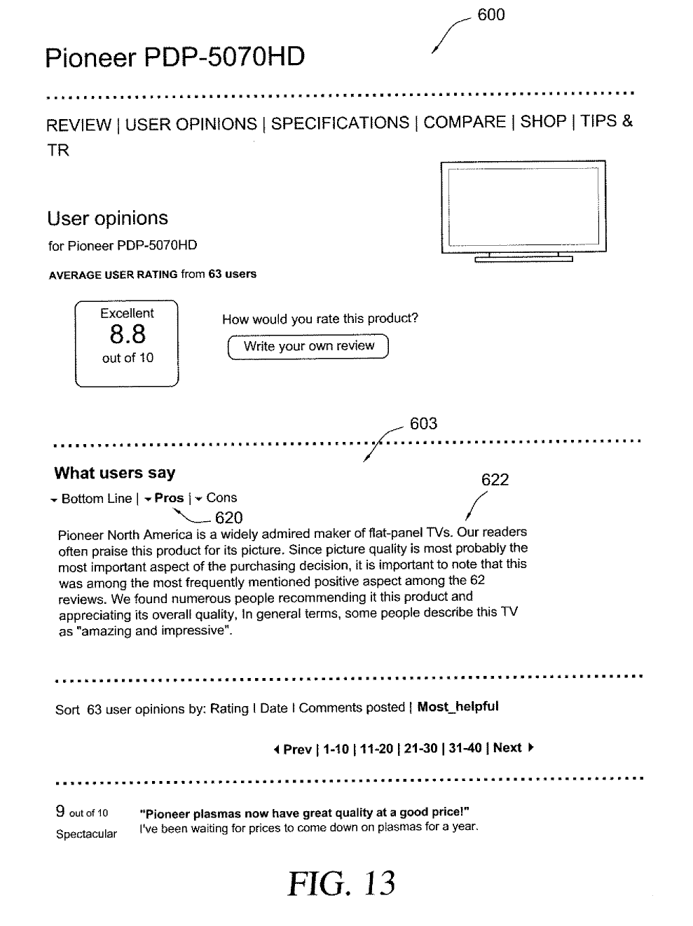

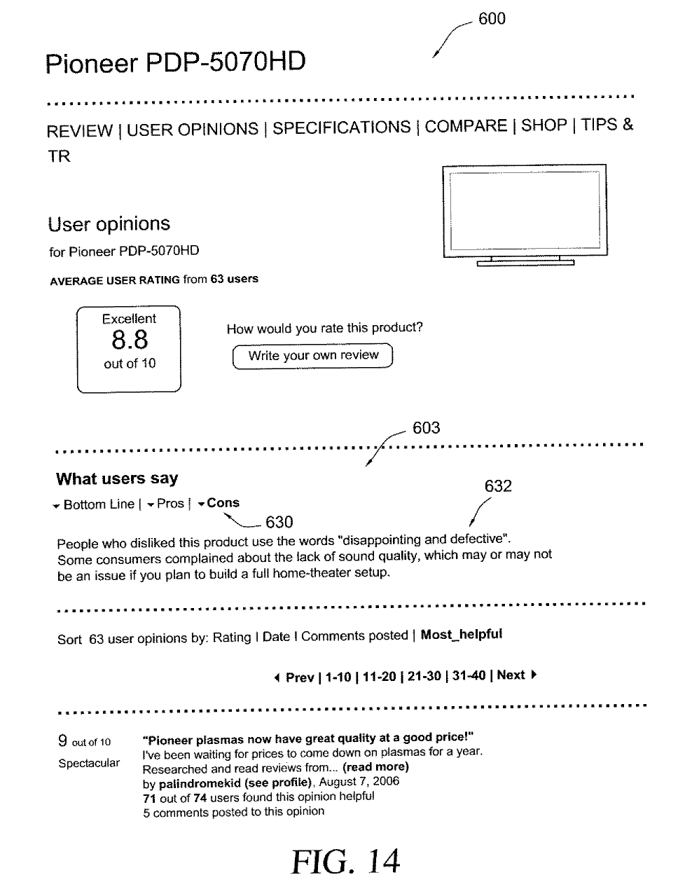

As can be appreciated, user opinion screen 600 of the illustrated example provides a final commentary regarding the product under the header “The bottom line” 606. Upon selection of the hyperlink “Pros” 620 as shown in FIG. 13, an evaluation summary 622 of the aspects of the product that were praised in the evaluative information (user opinions) is displayed in the evaluation summary section 603. Upon selection of the hyperlink “Cons” 630 as shown in FIG. 14, an evaluation summary 632 of the aspects of the product that were criticized or negatively commented on in the evaluative information is displayed in the evaluation summary section 603. Of course, the above noted titles of links, content, and arrangement of the product screen 600 is merely provided as one example, and the present invention is not limited thereto.

In view of the above, the described embodiments of the evaluative information system 10 demonstrate that (a) the system can provide category summaries and product summaries completely “from scratch” without a pre-existing catalog, making it relatively easy to enter a new product category for which the relevant product and evaluative information has not been aggregated, and (b) the system can provide category and product summaries equally well, and with even less setup time, in a case where a known product catalog and/or evaluative information collection is already available, such as in an existing web site that allows users to submit opinions, reviews and the like.

It should further be noted that whereas the above description of the evaluative information system 10 has been focused on generation of category and product summaries from aggregated evaluative information in text form (whether such information is from users or professionals), the present invention is not limited thereto. In this regard, such evaluative information may be in any media, provided that they have a text representation. Such evaluative information can be included for aggregation and analysis by the evaluative information system 10 of the present invention.

In particular, by utilizing different extraction techniques, audio and video streams/files and their associated metadata can be used as sources of evaluative information for aggregation and analysis. Many such files come packaged with tags and description fields already containing text which reflects their content so that such files can be readily used by the evaluative information system 10. In addition, there exist numerous speech recognition tools (especially the keyword-spotting type available from several vendors in the industry) that are suitable for extracting additional text phrases from such files for use by the evaluative information system 10.

Moreover, the evaluative information system 10 can optionally be further expanded to incorporate other types of user content and information for aggregation and analysis. In particular, various configuration scripts can be changed so that the evaluative information system 10 can be invoked for other types of user content/information that exhibits common forms across the industry. Examples of other types of user content and information that can be aggregated and analyzed include, but are not limited to: FAQ's, product update downloads, drivers, manuals, quick start guides, troubleshooting guides, rebates, forums, marketing materials (for accessories or services related to products), press releases, product recalls, government safety notices, and so on. The evaluative information system 10 can be modified so that all of these types of information can be aggregated and analyzed so that content there from, can be incorporated into the category summaries, product summaries and/or excerpts that are outputted by the evaluative information system 10.

Changes to the evaluative information system 10 to accommodate such additional content and information types may include substituting the product opinion acquirer 36 sub-module with a sub-module configured for acquiring other content/information types (e.g. sub-module that visits manufacturer sites for rebates and recall notices, to government sites for safety warnings, etc.), or adding such a sub-module. For each content/information type, different text-feature extraction patterns would be entered by the analyst 2 via interface module 24 using the various tools described herein. By adding these content and information types, and running evaluative information system 10 on a frequent basis, one can see that after the initial setup and tuning, a nearly automated process will be in place to provide users with both a broad view, and a detailed view of the entire product category on the one hand, and the specific aspects of a particular product on the other hand.

The evaluative information system 10 is preferably implemented so that it only needs to be updated periodically, or when new features, problems, or sub-types of products, are being talked about in the industry, or in the community of reviewers and users who are writing opinions in the various information sources 6. When such changes are identified, the analyst 2 can quickly add the new, relevant feature extraction, micro-grammar, and template information in the various configurators described above, without re-thinking the entire product category.

In the above regard, to further facilitate the updating process, the analyzer module 50 of the evaluative information system 10 may be implemented to monitor the content of the information sources 6 for differential frequency of vocabulary since the previous update. More specifically, if new words and phrases appear with a high frequency which were either not mentioned, or mentioned with only low frequency as of the previous update, then such new words and phrases can be copied and sent automatically to the analyst 2, for example, in an email, with a message suggesting that the analyst consider whether the new content represents a new feature in the product category that should be explicitly added to the evaluative information system 10 to update and improve the evaluation summaries generated.

Finally, it should also be apparent from the discussion above that in accordance with yet another aspect of the present invention, a computer readable medium for processing evaluative information from an information source is provided, the medium including instructions for implementing the above described evaluative information system and/or the computer implemented method.

While various embodiments in accordance with the present invention have been shown and described, it is understood that the invention is not limited thereto. The present invention may be changed, modified and further applied by those skilled in the art. Therefore, this invention is not limited to the detail shown and described previously, but also includes all such changes and modifications.

I/We claim:

1. An evaluative information system for summarizing evaluative information from at least one information source comprising:
a processor adapted to electronically communicate with the at least one information source;
an aggregator module in electronic communication with the processor, the aggregator module being adapted to locate and aggregate evaluative information regarding a product in a product category from the information source, the evaluative information including at least one of a review, a commentary, and an opinion regarding the product;
an analyzer module adapted to extract evaluative features in the evaluative information aggregated by the aggregator module; and
a generator module adapted to generate an evaluation summary for the product based on the extracted evaluative features so as to summarize evaluative information from the information source.

2. The evaluative information system of claim 1, wherein the aggregator module is further adapted to aggregate names of products in the product category.

3. The evaluative information system of claim 2, wherein the aggregator module aggregates names of products from at least one intermediary web site.

4. The evaluative information system of claim 1, wherein the analyzer module utilizes a plurality of text patterns to extract the evaluative features in the evaluative information aggregated.

5. The evaluative information system of claim 1, wherein the analyzer module is further adapted to extract secondary attributes in the evaluative information aggregated by the aggregator module, and the generator module generates evaluation summary for the product further based on the extracted secondary attributes.

6. The evaluative information system of claim 1, wherein the generator module is further adapted to generate a summary for the product category of the product based on the extracted evaluative features.

7. The evaluative information system of claim 1, further including an excerpt generator that copies excerpts of the evaluative information to generate excerpts for publication.

8. The evaluative information system of claim 7, wherein at least a portion of the generated excerpts are incorporated into the evaluation summary for the product.

9. The evaluative information system of claim 8, wherein at least a portion of a generated excerpt is provided as a hyperlink to the text of the evaluative information of the information source from which the excerpt was copied.

10. The evaluative information system of claim 1, wherein the generated evaluation summary includes at least one evaluative feature provided as a hyperlink to a generated excerpt.

11. The evaluative information system of claim 1, further including a publisher module adapted to electronically publish the evaluation summary for the product generated by the generator module.

12. A computer implemented method for processing evaluative information from at least one information source comprising:
electronically locating and aggregating evaluative information regarding a product in a product category from the at least one information source, the evaluative information being digitally stored and including at least one of a review, a commentary, and an opinion regarding the product;
electronically extracting evaluative features in the evaluative information aggregated;
electronically generating an evaluation summary for the product based on the extracted evaluative features so as to summarize evaluative information from the information source; and
electronically publishing the generated evaluation summary.

13. The method of claim 12, further including electronically aggregating names of products in the product category.

14. The method of claim 13, wherein the names of products are aggregated from at least one intermediary web site.

15. The method of claim 12, wherein electronic extraction of the evaluative features in the evaluative information aggregated is attained using a plurality of text patterns.

16. The method of claim 12, further including electronically extracting secondary attributes in the evaluative information aggregated, wherein the generated evaluation summary for the product is further based on the extracted secondary attributes.

17. The method of claim 12, further including electronically generating a summary for the product category of the product based on the extracted evaluative features.

18. The method of claim 12, further including electronically copying excerpts of the evaluative information, and electronically generating excerpts for publication.

19. The method of claim 18, further including electronically incorporating the generated excerpts into the evaluation summary for the product.

20. The method of claim 19, further including providing at least a portion of a generated excerpt as a hyperlink to the text of the evaluative information of the information source from which the excerpt was copied.

21. The method of claim 12, further including providing at least one evaluative feature in the generated evaluation summary as a hyperlink to a generated excerpt.

22. A computer readable medium for processing evaluative information from at least one information source, the medium comprising:
instructions for electronically locating and aggregating evaluative information regarding a product in a product category from the at least one information source, the evaluative information being digitally stored and including at least one of a review, a commentary, and an opinion regarding the product;
instructions for electronically extracting evaluative features in the evaluative information aggregated; and
instructions for electronically generating an evaluation summary for the product based on the extracted evaluative features so as to summarize evaluative information from the information source.

23. The medium of claim 22, further including instructions for electronically aggregating names of products in the product category.

24. The medium of claim 23, wherein the names of products are aggregated from at least one intermediary web site.

25. The medium of claim 22, wherein instructions for electronically extracting the evaluative features in the evaluative information aggregated includes instructions for use of a plurality of text patterns.

26. The medium of claim 22, further including instructions for electronically extracting secondary attributes in the evaluative information aggregated, wherein the generated evaluation summary for the product is further based on the extracted secondary attributes.

27. The medium of claim 22, further including instructions for electronically generating a summary for the product category of the product based on the extracted evaluative features.

28. The medium of claim 22, further including instructions for electronically copying excerpts of the evaluative information, and instructions for electronically generating excerpts for publication.

29. The medium of claim 28, further including instructions for electronically incorporating the generated excerpts into the evaluation summary for the product.

30. The medium of claim 29, further including instructions for providing at least a portion of a generated excerpt as a hyperlink to the text of the evaluative information of the information source from which the excerpt was copied.

31. The medium of claim 22, further including instructions for providing at least one evaluative feature in the generated evaluation summary as a hyperlink to a generated excerpt.

32. The medium of claim 22, further including instructions for electronically publishing the generated evaluation summary.
